(19) United States
(12) Patent Application Publication
(10) Pub. No.: US 2008/0014919 A1
(43) Pub. Date: Jan. 17, 2008

(54) ILLUMINATION SYSTEM FOR PORTABLE ELECTRONIC DEVICES

(75) Inventors: ELIOT KIM, LISLE, IL (US); DANIEL WILLIAM JARVIS, HAINESVILLE, IL (US); CLAUDIO SANTIAGO RIBEIRO, EVANSTON, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/457,827

(22) Filed: Jul. 17, 2006

(51) Int. Cl. H04Q 7/20

(52) U.S. Cl. 455/425

(57) ABSTRACT

An illumination system for a portable electronic device (100) is provided. The portable electronic device comprises a first housing (102) having a user interface (202), and a second housing (104) having at least one light source. The second housing is slideably coupled to the first housing. Further, the second housing is capable of sliding linearly over the first housing between a first position and a second position. In the first position, the second housing conceals at least a portion of the user interface. In the second position, the second housing reveals at least a portion of the user interface. The at least one light source is capable of illuminating at least a portion of the user interface when the second housing is in the second position. Furthermore, the second housing is designed to conceal the at least one light source.

### FIELD OF THE INVENTION

This invention relates in general to portable electronic devices, and more specifically, to an illumination system for portable electronic devices.

### BACKGROUND OF THE INVENTION

In recent years, there has been an increase in the use of portable electronic devices, such as mobile phones, pagers, portable radios, remote controls, portable audio and video players, portable gaming devices, and Personal Digital Assistants (PDAs) in communication, entertainment, data storage, and data processing. A portable electronic device can include a user interface that enables a user to provide an input to obtain a desired output from the portable electronic device. Some examples of user interfaces include a keypad, a joystick, and a touch pad. The user interface can include one or more keys corresponding to predetermined functions. For example, a typical mobile phone keypad can include alphanumeric keys, menu navigation keys, a call-start key, and a call-end key. The function performed by a key can be represented by markings in the form of character(s) and/or symbol(s) on the key. The markings on the user interface help a user to provide a desired input to the portable electronic device.

To facilitate reading of the markings on the keys, portable electronic devices have arrangements for illuminating the keypad. One of the known methods for illuminating the keypad of a portable electronic device is the use of back lighting. In this method, one or more light sources, such as, Light Emitting Diodes (LEDs), are placed under the keypad. These LEDs illuminate the keys and make the markings on the keys visible to a user. However, light emitted by an LED, placed under the keypad, spreads to a very limited area over the keypad. Consequently, to ensure adequate illumination of the entire keypad, a larger number of LEDs is required. An Increase in the number of LEDs results in battery current drain and reduces battery life. Using more of LEDs also adds to the cost of the portable electronic device. Further, more LEDs require additional space and result in the portable electronic device being increased. Moreover, the LEDs placed under the keypad for back lighting cannot be used to illuminate other parts of the portable electronic device.

### BRIEF DESCRIPTION OF THE FIGURES

The present invention is illustrated by way of example and not limitation in the accompanying figures, in which like references indicate similar elements, and in which:

FIG. 1 is a block diagram illustrating an exemplary portable electronic device, in accordance with an embodiment of the present invention;

FIG. 2 is a perspective view illustrating an exemplary portable electronic device, in accordance with an embodiment of the present invention;

FIG. 3 is a perspective view illustrating a second position of an exemplary portable electronic device, in accordance with an embodiment of the present invention;

FIG. 4 is a perspective view illustrating at least one light source of an exemplary portable electronic device, in accordance with an embodiment of the present invention;

FIG. 5 is a cut-away side view illustrating at least one light source of an exemplary portable electronic device, inclined at a predefined angle, in accordance with an embodiment of the present invention;

FIG. 6 is a perspective view illustrating an exemplary light dispersing medium of an exemplary portable electronic device, in accordance with an embodiment of the present invention;

FIG. 7 is a front view illustrating photo luminescent markings on an exemplary portable electronic device, in accordance with an embodiment of the present invention; and

FIG. 8 is a back view illustrating a rail guide of an exemplary portable electronic device, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the particular system for illuminating a portable electronic device, in accordance with the present invention, it should be observed that the present invention resides primarily in apparatus components related to the system for illuminating a portable electronic device. Accordingly, the apparatus components have been represented where appropriate by conventional symbols in the drawings, showing only those specific details that are pertinent to understanding the present invention, so as not to obscure the disclosure with details that will be readily apparent to those of ordinary skill in the art, having the benefit of the description herein.

In this document, relational terms such as first and second, and the like may be used solely to distinguish one entity or action from another entity or action without necessarily requiring or implying any actual such relationship or order between such entities or actions. The terms ‘comprises,’ ‘comprising,’ ‘includes’ , ‘including,’ or any other variation thereof, are intended to cover a non-exclusive inclusion, such that a process, article, system or apparatus that comprises a list of elements does not include only those elements but may include other elements not expressly listed or inherent to such process, article, or apparatus. An element preceded by ‘comprises . . . a’ does not, without more constraints, preclude the existence of additional identical elements in the process, article, system, or apparatus that comprises the element. The terms “includes” and/or “having”, as used herein, are defined as comprising.

The present invention describes a system for illuminating a portable electronic device. The portable electronic device includes a first housing and a second housing. The first housing includes a user interface. The second housing is slideably coupled to the first housing and is capable of sliding linearly over the first housing between a first position and a second position. In the first position, the second housing conceals at least a portion of the user interface. In the second position, the second housing reveals at least a portion of the user interface. The second housing includes at least one light source that is capable of illuminating at least a portion of the user interface when the second housing is in the second position. Further, the second housing is designed to conceal the at least one light source.

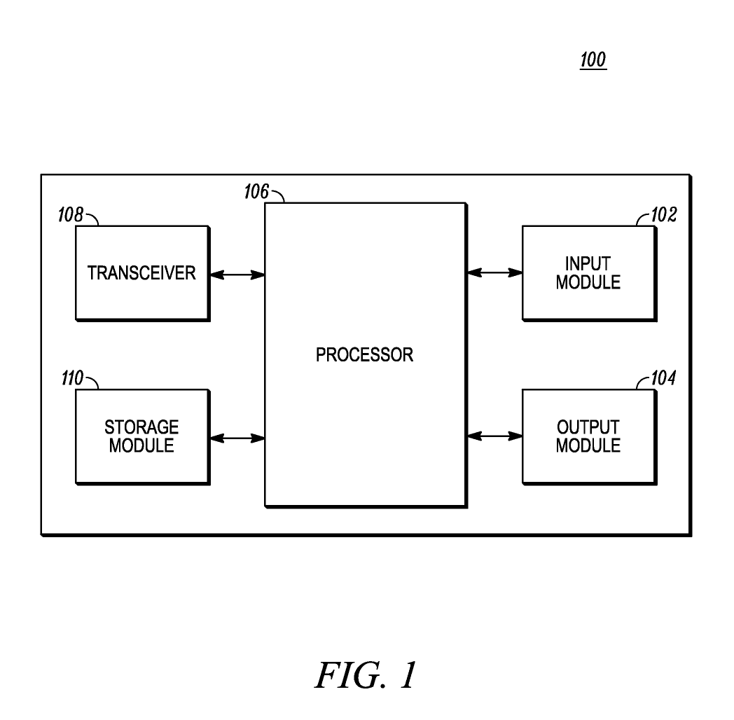

Referring to FIG. 1, there is shown a block diagram illustrating an exemplary portable electronic device 100, in accordance with the present invention. Examples of the portable electronic device 100 include, but are not limited to, mobile phones, and Personal Digital Assistants (PDAs). The portable electronic device 100 includes an input module 102, an output module 104, a processor 106, a transceiver 108, and a storage module 110. The input module 102 is used to provide necessary inputs to the portable electronic device 100. The input is provided to obtain a desired output. Examples of the input module 102 include, but are not limited to, a keypad, a navigational element, a touch pad, and one or more menu and/or special purpose keys. The output module 104 is used to provide the desired output. Examples of the output module 104 include, but are not limited to, a display screen and one or more speakers. The input module 102 and the output module 104 are communicably coupled to the processor 106. The processor 106 is used for executing various functions to perform a desired task for the portable electronic device 100. Further, the processor 106 is communicably coupled to the transceiver 108 and the storage module 110. The transceiver 108 is used for transmitting and receiving one or more signals for the portable electronic device 100. The storage module 110 is used for storing data, which can be used by the processor 106 for executing various functions.

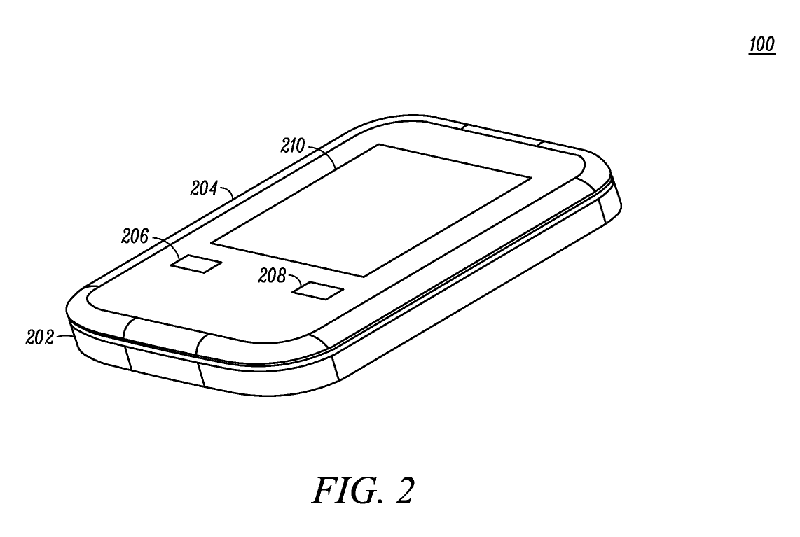

Referring to FIG. 2, there is shown a perspective view illustrating an exemplary portable electronic device 100, in accordance with the present invention. Examples of the portable electronic device 100 include, but are not limited to, mobile phones, pagers, portable radios, remote controls, portable audio players, portable video players, portable gaming devices, and Personal Digital Assistants (PDAs). In one embodiment, the portable electronic device 100 includes a first housing 202 and a second housing 204. The second housing 204 can include, for example, menu keys 206 and 208, and a display screen 210. In one embodiment, the second housing 204 can include a keypad, a navigational element, a touch pad, and one or more menu and/or special purpose keys.

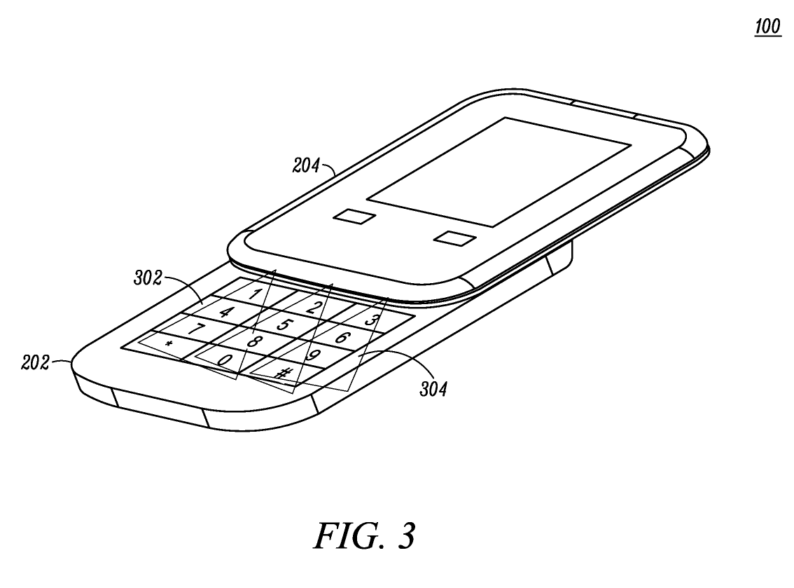

Referring to FIG. 3, there is shown a perspective view illustrating the exemplary portable electronic device 100 in a second position, in accordance with the present invention. In one embodiment, the first housing 202 of the portable electronic device 100 can include a user interface 302. Examples of the user interface 302 include, but are not limited to, a keypad, a navigational element, and a touch pad. In one embodiment, the navigational element can be a joystick, a navigational disc, a scroll wheel, or cursor keys. Further, the second housing 204 is slideably coupled to the first housing 202. In one embodiment, the second housing 204 is capable of linearly sliding over the first housing 202 between a plurality of positions. The plurality of positions can be, for example, a first position and a second position. The second housing 204 can conceal at least a portion of the user interface 302 in the first position. On the other hand, the second housing 204 can reveal at least a portion of the user interface 302 in the second position. In one embodiment, the second housing 204 conceals the user interface 302 in the first position, as shown in FIG. 2. In another embodiment, the second housing 204 reveals the user interface 302 in the second position, as shown in FIG. 3. Further, the second housing 204 can include at least one light source capable of illuminating at least a portion of the user interface 302 when the second housing 204 is in the second position. In another embodiment, the at least one light source is capable of illuminating at least a portion of the user interface 302 when the second housing 204 is between the first position and the second position. In one embodiment, the at least one light source casts a curtain of light 304 on to the user interface 302 when the second housing 204 is in the second position. In another embodiment, the at least one light source can produce a stadium light effect to illuminate the user interface 302.

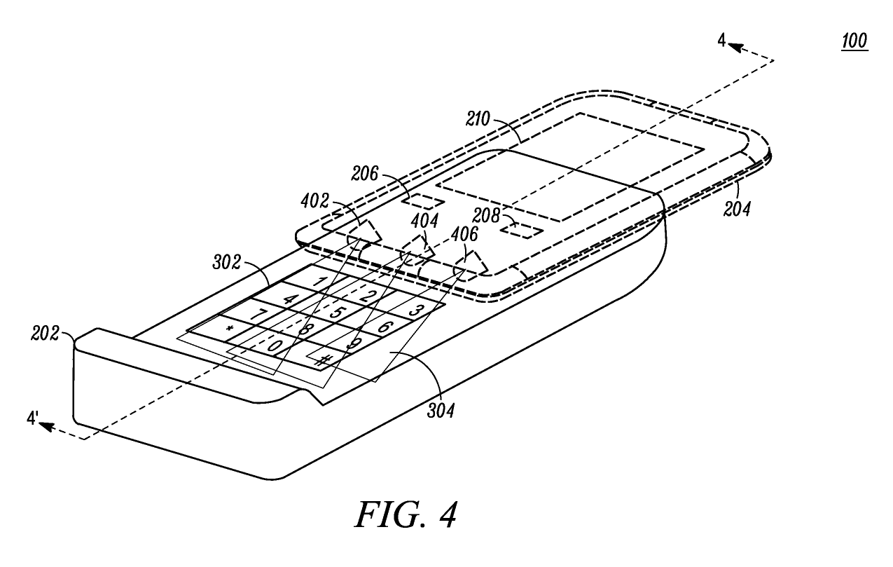

Referring to FIG. 4, there is shown a perspective view illustrating at least one light source of the exemplary portable electronic device 100, in accordance with the present invention. In one embodiment, the at least one light source can emit Ultra Violet (UV) or visible light. Further, the at least one light source can be a color light source, for example, a red, blue, green, or white light source. Additionally, the at least one light source can be a UV light source, for example, a black light or a dark purple light source. Examples of the at least one light source include, but are not limited to, a Light Emitting Diode (LED), an incandescent light source, and an Electro Luminescent (EL) film panel. For the purpose of this description, the portable electronic device 100 is shown to include three LEDs, for example, LED 402, LED 404, and LED 406, to illustrate the at least one light source. The LEDs can illuminate at least a portion of the user interface 302 by casting the curtain of light 304 on to the user interface 302 when the second housing 204 is in the second position. In one embodiment, at least one of the LEDs can be configured to illuminate one or more of the menu keys 206 and 208, navigational keys, special purpose keys, a keypad, a navigational element, a touch pad, and the display screen 210 in the second housing 204. In one embodiment, the portable electronic device 100 can also include at least one switch for activating the LEDs when the second housing 204 is in the second position. Examples of the at least one switch include, but are not limited to, a mechanical switch, an electrical switch, and an electromechanical switch.

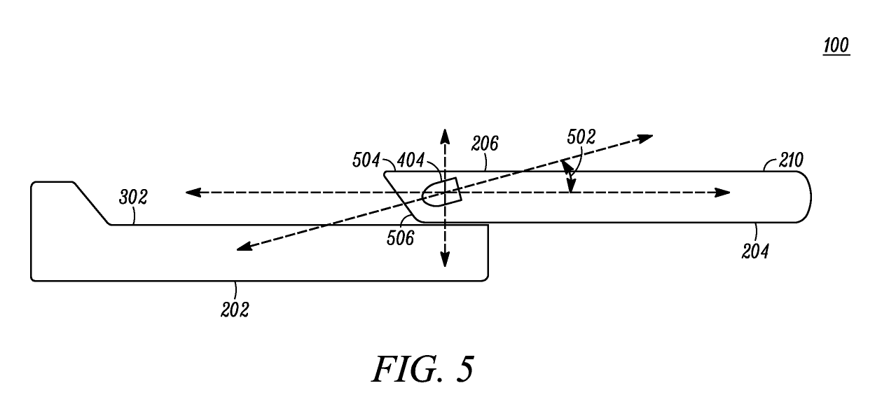

Referring to FIG. 5, there is shown a side-cut view along the axis 4-4′ in FIG. 4 illustrating the at least one light source, inclined at a predefined angle 502, of the exemplary portable electronic device 100, in accordance with the present invention. For the purpose of this description, the portable electronic device 100 is shown to include the LED 404 to illustrate the at least one light source. The LED 404 can be positioned in the second housing 204 such that light emitted from the LED 404 can be directed on to the user interface 302. To achieve this, the LED 404 can be inclined at the predefined angle 502 with respect to the plane of the second housing 204. The predefined angle 502 can be within a range of zero to 90 degrees, for example, 45 degrees. Placing the LED 404 at the predefined angle 502 ensures that light emitted is primarily directed on the user interface 302.

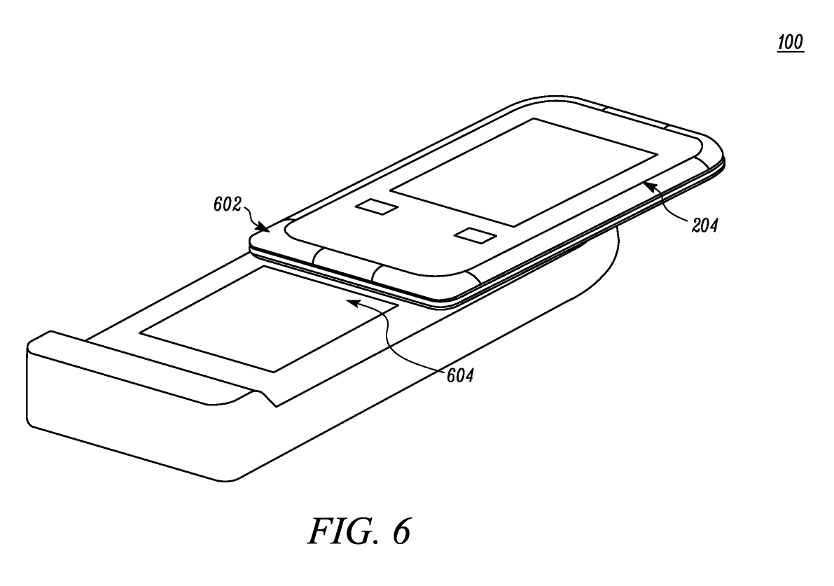

In one embodiment, the second housing 204 can also include a light dispersing medium to cast a curtain of light over the user interface 302. Examples of the light dispersing medium include, but are not limited to, a reflector and an optical lens. An exemplary light medium is illustrated in FIG. 6. Other examples of the light dispersing medium can include tail-light lens of a car, lens on a camera flash, and lens on car headlights. The light dispersing medium can have molded geometry to optically direct light in a certain direction or on a certain object. The light dispersing medium can be configured to direct light emitted by the LED 404 on to the user interface 302. In one embodiment, the light dispersing medium can be configured to illuminate one or more of the menu keys 206 and 208, navigational keys, special purpose keys, a keypad, a navigational element, a touch pad, and the display screen 210 in the second housing 204.

The second housing 204 includes an upper surface 504 adjacent to the at least one light source. The upper surface 504 is designed to conceal the at least one light source. In another embodiment, the second housing 204 can include an inclined edge 506 to conceal the at least one light source. In another embodiment, the second housing 204 can be designed similar to an under kitchen cabinet for concealing the at least one light source. In yet another embodiment, second housing 204 can be designed similar to an indirect cove illumination for architectural lighting for concealing the at least one light source. In still another embodiment, the second housing 204 can be designed similar to a concealed display case lighting for concealing the at least one light source. The at least one light source is concealed to keep hot spots of the at least one light source away from plain view of a user.

Referring to FIG. 6, there is shown a perspective view illustrating an exemplary light dispersing medium 602 of the portable electronic device 100, in accordance with an embodiment of the present invention. The light dispersing medium 602 can be configured to direct the light on to a user interface 604. In this embodiment, the light dispersing medium 602 is concealed in the second housing 204.

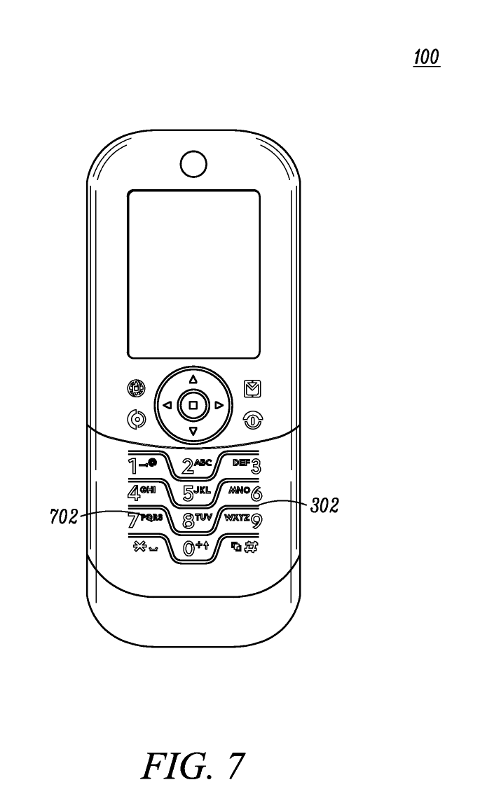

Referring to FIG. 7, there is shown a front view illustrating photo luminescent markings 702 on the portable electronic device 100, in accordance with the present invention. The user interface 302 can include printed characters or laser etchings to indicate functionality of various keys of the user interface 302. In order to make the markings easily visible to a user, the user interface 302 can include photo luminescent markings 702. Examples of the photo luminescent markings 702 include, but are not limited to, phosphorescent markings and fluorescent markings. Other examples of the photo luminescent markings 702 can be similar to markings on road-side signboards, markings on minutes-hand and hours-hand of a watch or a clock, and markings on display boards for giving directions in an auditorium. The photo luminescent markings 702 respond to light radiations and produce a glowing effect to improve visibility of the user interface 302 in case the surrounding light is poor. In another embodiment, the photo luminescent markings 702 can continue to glow after being briefly illuminated by the at least one light source to enhance visibility of the user interface 302.

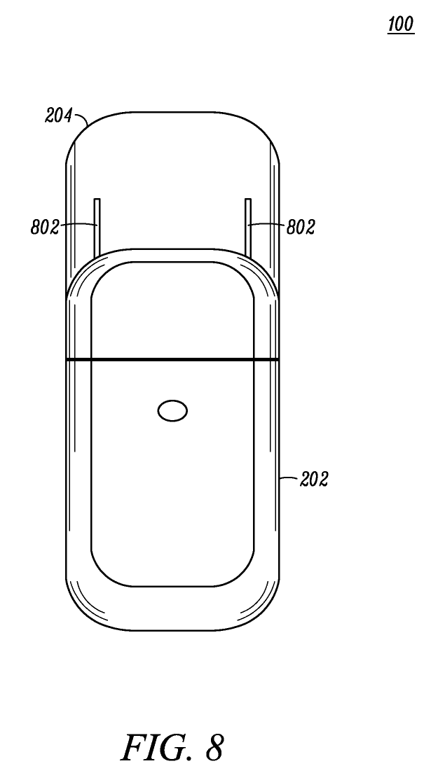

Referring to FIG. 8, there is shown a back view of the exemplary portable electronic device 100 illustrating a rail guide 802, in accordance with the present invention. In one embodiment, the second housing 204 is capable of sliding linearly over the first housing 202. The second housing 204 can be slideably coupled to the first housing 202, by, for example, a gear assembly or a bush and rod assembly. In one embodiment, the second housing 204 and the first housing 202 are slideably coupled by a rail and guide assembly. In this embodiment, a rail can be positioned in the first housing 202. Further, the rail guide 802 can be positioned in the second housing 204. The rail moves with the help of the rail guide 802 when the second housing 204 slides from the first position to the second position.

The present invention provides a system for externally illuminating a user interface of a portable electronic device. One or more light sources can be positioned above the user interface which can cast a bright light curtain over the user interface to enhance visibility of the user interface. Further, the light sources can be concealed in the portable electronic device. Since the use interface is externally illuminated by the at least one light source, light emitted by the at least one light source spreads over a larger area of the user interface. Consequently, a fewer number of light sources is required to illuminate the user interface. Further, the light sources used for externally illuminating the user interface can also be used to illuminate other parts of the portable electronic device, for example, navigational elements and display screen. This further reduces the number of light sources required in the portable electronic device. Minimizing the number of light sources ensures lower battery drain and longer battery life. A reduction in number of light sources also results in overall cost reduction of the portable electronic device. Moreover, a fewer number of light sources consumes less space in the portable electronic device, which results in overall size reduction of the device. Further, the space saved by reducing the number of light sources can be used to accommodate other components of the portable electronic device, for example, an antenna. Moreover, the present invention enhances the appearance of the portable electronic device, due to the lighting effect, by providing a unique ‘night club ambience’ to the device.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A portable electronic device comprising:
a first housing having a user interface; and
a second housing slideably coupled to the first housing, the second housing capable of linearly sliding over the first housing between a first position in which the second housing conceals at least a portion of the user interface and a second position in which the second housing reveals at least a portion of the user interface, wherein the second housing comprises at least one light source capable of illuminating at least a portion of the user interface when the second housing is in the second position, and wherein the second housing comprises an upper surface adjacent to the at least one light source on a side opposite to the first housing.

2. The portable electronic device as recited in claim 1, wherein the second housing is slideably coupled to the first housing by one of a rail and guide assembly, a gear assembly, and a bush and rod assembly.

3. The portable electronic device as recited in claim 1, wherein the second housing comprises an inclined edge, wherein the inclined edge conceals the at least one light source.

4. The portable electronic device as recited in claim 1, further comprising at least one switch for activating the at least one light source.

5. The portable electronic device as recited in claim 4, wherein the at least one switch is selected from a group comprising a mechanical switch, an electrical switch, and an electro-mechanical switch.

6. The portable electronic device as recited in claim 1, wherein the user interface is selected from a group comprising a keypad, a navigational element and a touch pad.

7. The portable electronic device as recited in claim 1, wherein the user interface comprises photo luminescent markings.

8. The portable electronic device as recited in claim 1, wherein the photo luminescent markings are selected from a group comprising phosphorescent markings and fluorescent markings.

9. The portable electronic device as recited in claim 1, wherein the at least one light source is selected from a group comprising an Ultra Violet (UV) light emitting source and a visible light emitting source.

10. The portable electronic device as recited in claim 1, wherein the at least one light source is selected from a group comprising a Light Emitting Diode (LED), an incandescent light source, and an Electro Luminescent (EL) film panel.

11. The portable electronic device as recited in claim 1, wherein the at least one light source is inclined at a predefined angle with respect to the second housing.

12. The portable electronic device as recited in claim 11, wherein the predefined angle is within a range between zero degrees and 90 degrees.

13. The portable electronic device as recited in claim 1, wherein the second housing further comprises a light dispersing medium for directing light emitted by the at least one light source on to the user interface.

14. The portable electronic device as recited in claim 13, wherein the light dispersing medium is selected from a group comprising a reflector and an optical lens.

15. The portable electronic device as recited in claim 1, wherein the at least one light source is configured to illuminate one or more of menu keys, navigation keys, special purpose keys, a keypad, a navigational element, a touch pad, and a display screen in the second housing.
